(19) United States
(12) Patent Application Publication
(10) Pub. No.: US 2010/0044657 A1
(43) Pub. Date: Feb. 25, 2010

(54) Adjustable lifting tool

(75) Inventors: Christopher Patrick, Derry, PA (US); Daniel J. Colcombe, Derry, PA (US)

Correspondence Address: Christopher Patrick, 615 Strawcutter Rd., Derry, PA, 15627, US

(73) Assignee: Lifting Master, Inc., Derry, PA (US)

(21) Appl. No.: 12/384,824

(22) Filed: Apr. 9, 2009

Related U.S. Application Data
(60) Provisional application No. 61/123,576, filed on Apr. 10, 2008.

(51) Int. Cl. B66F 15/00; B66F 3/00

(52) U.S. Cl. 254/130; 254/129; 254/131

(57) ABSTRACT

The present invention is a tool which provides a method for lifting. The tool has an adjustable handle member configured to be grasped by a user, joined to a lifting arm which is configured to engage an object to be lifted. The handle member and the lifting arm are rigidly connected at a vertex and form an obtuse angle there between. Further, the tool has an adjustable pedestal with a rocker base near the vertex, which allows forward and backward displacement of the tool during the raising and lowering an object.

### THE FIELD OF THE INVENTION

The present invention relates generally to a lifting tool. More particularly, it concerns a tool for lifting an object which is configured to maintain the horizontal integrity of at least a portion of the lifted object.

### BACKGROUND OF THE INVENTION

Often situations arise where an object, such as a piece of furniture, must be lifted in order to retrieve an article which is underneath the object, or to place an article, such as a support, underneath the object. The act of lifting an object of significant size and weight is difficult and may pose a risk of injury. Further, the task of simultaneously lifting the object and retrieving an article, or placing an article under the object in a specific location, is especially inconvenient and difficult for a single person to perform.

Additional situations may arise where an object must be raised to a certain height and then fixed to a second object while suspended. For example, to install a tire on an automobile, the tire must be lifted and affixed to a wheel base. Such a task requires the simultaneous effort of lifting, aligning, and affixing, which can often be inconvenient and difficult for one person to perform alone.

Situations of these types occur regularly in certain industries. For example in the cleaning industry, and more particularly, in the carpet cleaning industry, a technician is required to lift furniture of varying heights to place one or more support articles, such a skidders, blocks, or tabs, underneath the furniture prior to cleaning. Once the skidders are in place, the furniture may be moved with ease and with little risk of damage or wear to the carpet or injury to the technician. Alternatively, support blocks may allow cleaning under the furniture without moving it from the area to be cleaned.

In the industry of automotive repair, a mechanic often finds himself changing, or rotating heavy tires of a truck for a customer. In this case, the side of the car on which the designated tire is located may be raised using a jack, and the tire removed. Once the repaired or new tire is ready, it must be properly aligned with the lugs, and then affixed to the wheel base. As the side of the truck is raised, and the heavy tire must be simultaneously be lifted, aligned with the lugs, and affixed to the wheel base. The performance of such tasks simultaneously is inconvenient and difficult.

When placing an article under a lifted object, it may be desired or necessary that a certain portion of the object come to rest upon the article. For example, when placing skidders under a sofa with legs, is necessary that the legs come to rest upon the skidders. Therefore, each skidder must be placed with precision in a spot on the floor where it can be predicted with confidence that the leg will come to rest when the sofa is lowered. In order to increase the convenience and accuracy of making such a prediction, the integrity of the horizontal positioning of a least a portion of the sofa must be maintained. Otherwise, if the entire sofa travels horizontally while it is being lifted, the location where the lifted portion will come to rest when it is lowered will be difficult to estimate. Prevention of horizontal traveling of an object due to lifting may also be desired in certain circumstances in order to prevent damage or wear on the object itself, or the floor on which it rests. For example, a dining room table which is allowed to scrape horizontally for any distance across a finished wood floor may cause marring or scratching to the floor. Further, the dragging of an appliance, such as washing machine may cause damage to the floor and the appliance. In such a case, it would be desirable, if not imperative, to lift the object and place or retrieve and article hereunder without causing any horizontal movement of the unlifted portion.

### SUMMARY OF THE INVENTION

It has been recognized that it would be advantageous to develop a lifting tool which facilitates the lifting and lowering of an object of substantial size and weight. In addition, it has been recognized that it would be advantageous to develop a lifting tool which can be operated with one hand, allowing a user to simultaneously perform a second function in addition to the lifting. In addition, it has been recognized that it would be advantageous to develop a lifting tool which allows an object to be lifted while maintaining the integrity of the horizontal position of at least a part of the object. In addition, it has been recognized that it would be advantageous to develop a lifting tool which allows the lowering of a raised object into the same original horizontal position is desirable.

Accordingly, the present invention provides a lifting tool constructed of a main lifting arm with an adjustable handle configured to be grasped by the user. The main lifting arm is constructed to form an obtuse angle there between and has an adjustable pedestal coupled at the vertex.

The present invention also encompasses a method of lifting an object using the lifting tool.

Such a method includes providing a lifting tool as disclosed herein, engaging a portion of an object with the lifting arm of the tool, applying a downward force on the handle member of the tool, to lower the handle member and raise the lifting arm, thus lifting the portion of the object, and simultaneously horizontally displacing the lifting tool to arrest horizontal displacement of the entire object, and maintain the horizontal position of at least a portion of the object.

In one aspect, only a portion of the object may be lifted, and another portion of the object may not be lifted. In such a case, the object pivots about a horizontal axis created by the unlifted portion the object. In another aspect, the entire object may be lifted. In one aspect, the downward force applied to the handle member may be applied to the handle with a single hand. In a further aspect, the method further includes simultaneously performing a second function near the scoop of the lifting tool with a second hand. In one aspect, the second function may be placing a support under the lifted portion of the object at a place on the ground which was in contact with the object. In yet another aspect, the method may further include lowering the object to rest upon the support.

In one aspect, the method of the present invention may also include the steps of removing the force applied to the handle member to lower the lifting arm and simultaneously horizontally displacing the lifting tool, in a direction opposite to an original direction of displacement, in order to arrest horizontal relocation of the object and return the object to its original horizontal position. In another aspect, the method of the present invention may also include the steps of vertically aligning the lifted object with an elevated point to which the object is to be affixed, affixing the lifted to the point, and removing the lifting tool from under the lifted object. There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, and/or may be learned by the practice of the invention.

### BRIEF DESCRIPTION OF THE DRAWING

FIG. 1 is a side view of a user employing a lifting tool in accordance with the present invention to lift an object and place an article beneath the object.

FIG. 2a is a side view of one embodiment of a lifting tool in accordance with the present invention.

FIG. 2b is a side view of one embodiment of a lifting tool shown with the adjustable handle retracted and the rocker base retracted in accordance with the present invention.

FIG. 2c is a side view of one embodiment of a lifting tool shown with the adjustable handle extended and the rocker base extended in accordance with the present invention.

FIG. 3 is a side view of one embodiment of a lifting tool in accordance with the present invention oriented with the handle retracted lifting an object with limited space next to a wall in accordance with the present invention in a second working position, lifting an object.

FIG. 4 is a side view of one embodiment of a lifting tool in accordance with the present invention oriented with the handle extended for extra leverage to lift a heavy object in accordance with the present invention in a third working position lifting an object.

FIG. 5 is a side view of one embodiment of a lifting tool showing rocker base retracted in use lifting an object that is sitting flat on the ground in accordance with the present invention in a fourth working position lifting an object.

FIG. 6 is a side view of one embodiment of a lifting tool showing rocker base extended in use lifting an object that is raised above the ground in accordance with the present invention in a fifth working position lifting an object.

FIG. 7 is a detail showing the spring pin in the adjustable handle in accordance with the present invention.

FIG. 8 is a detail showing the solid spring pin in the adjustable rocker base in accordance with the present invention.

FIG. 9 is a detail of the rocker base placement in accordance with the present invention.

FIG. 10a is a side view of the placement of the support leg in accordance with the present invention.

FIG. 10b is a section view of the placement of the support leg in accordance with the present invention.

### DETAILED DESCRIPTION

Before the present lifting tool is disclosed and described, it is to be understood that this invention is not limited to the particular design and material disclosed herein, but is extended to equivalents thereof as would be recognized by those ordinarily skilled in the relevant arts. It should also be understood that terminology employed herein is used for the purpose of describing particular embodiment only, and is not intended to be limiting.

In describing and claiming the present invention, the following terminology will be used in accordance with the definitions set forth below.

As used herein, “vertex” refers to the point at which two lines intersect to form an angle.

As used herein, “obtuse” refers to an angle which is greater than 90.0 degrees, and less than 180.0 degrees.

As used herein, “acute” refers to an angle which is greater than 0.0 degrees, and less than 90.0 degrees.

As used herein, “ground” and “floor” may be used synonymously, and refer to a surface upon which the lifting tool rests when being employed to lift an object.

Height, length, and other dimensions, or numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

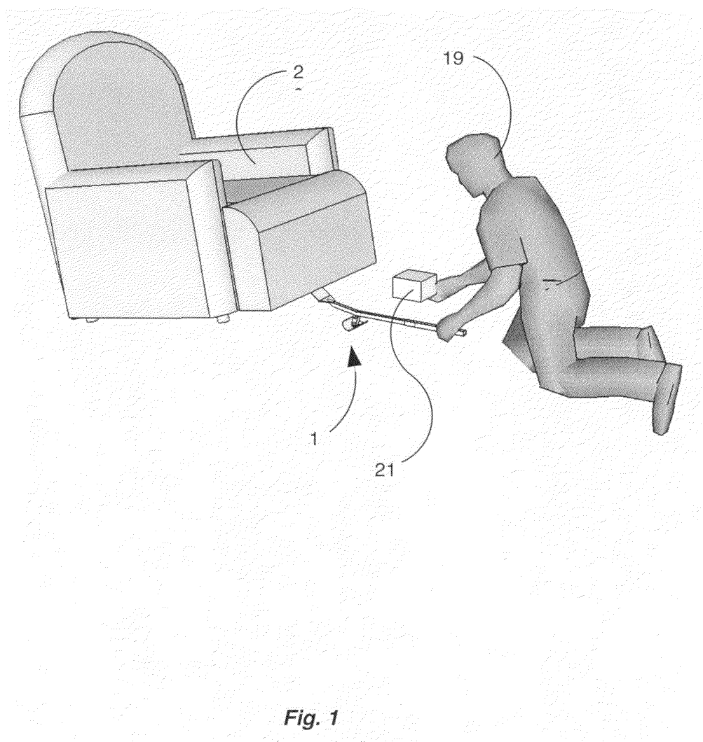

Referring now to FIG. 1 is shown a side view of a user 19, engaged in one aspect of the general method of the present invention by operating lifting tool 1 with one hand to lift object 20, and simultaneously placing a slide pad 21, under lifted object 20 using a second hand is one possible embodiment of the lifting tool being used by user 19.

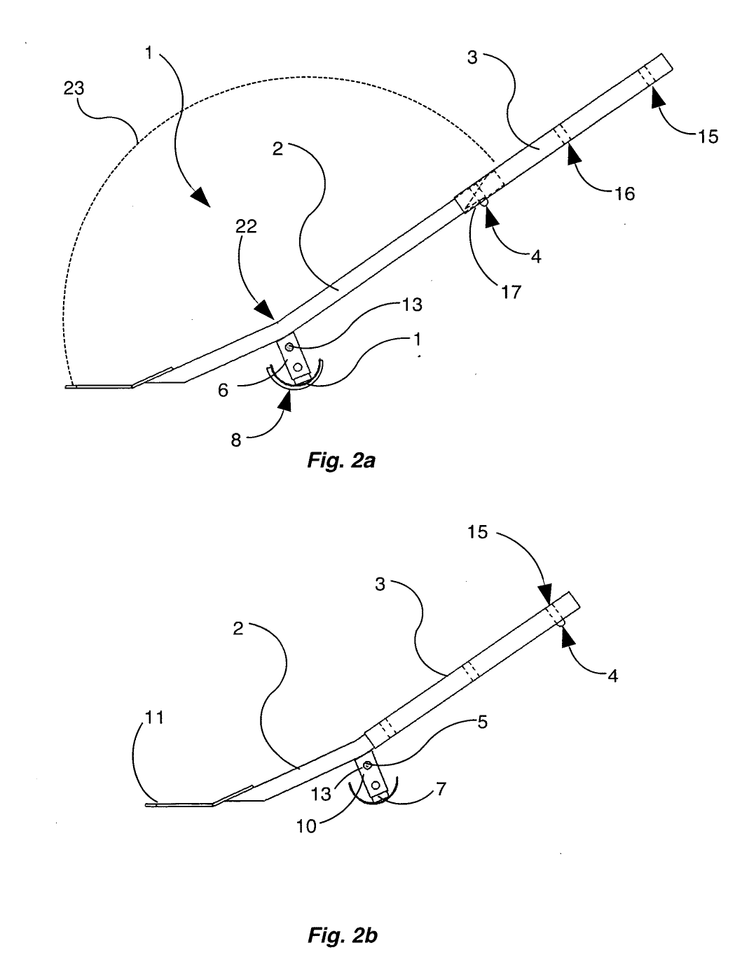

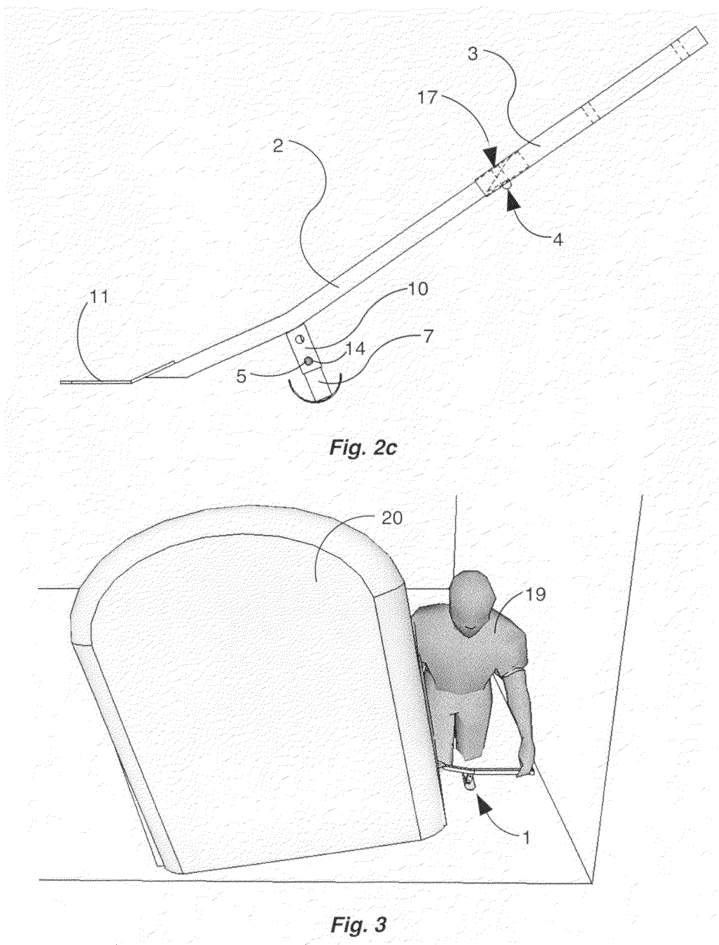

Referring now to FIG. 2A is shown the side view of the lifting tool 1 in accordance with one embodiment of the present invention. Lifting tool 1, generally includes an adjustable handle member 3, which is configured to be grasped by a user, and is designed to slide over the main support member to allow the user to adjust the length of the handle, to one of 3 adjustable positions a retracted position 15, a centered position 16, and an extended position 17, with a hollow spring button 4 on lifting arm 2 which is configured to engage an object. Handle member 3 and lifting arm 2 are coupled at a vertex 22, and form an obtuse angle 23 therebetween. Further, the rocker base pedestal is coupled to the lifting tool 1 at or near vertex 22.

The handle member 3 and lifting arm 2 may take the form of any one of a wide variety of suitable structures conceivable by one skilled in the art. Lifting arm 2 is a single integral elongated shaft. Such a shaft may be solid or hollow. While this shaft is depicted with a square shape in FIG. 1, the shape and size of handle member 3 and lifting arm 2 may be of a wide range of shapes and dimensions, such a circular, oval, triangular, hexagonal, etc. The adjustable handle that slides over the top is an important feature to allow for the full range of adjustability.

Referring again to FIG. 2, stable rocker base 8, is shown slid inside pedestal 6 that has two adjustable positions, a retracted position 13 and an extended position 14 that are adjusted using an integral spring button 5. The rocker base 7 is covered with a durable Teflon film 8 to provide protection to the base surface and allow the tool to slide back and forth as needed during a lift. The scoop as shown is FIG. 1 cradles and supports the object being lifted and has a slight bend to allow the scoop to sit flat on the floor when positioned in the retracted setting.

As depicted in FIG. 2B is a side view of lifting tool 1, with handle 3, shown in a retracted position with hollow spring button 4 shown in position 15 of handle 3 to allow the operator 19 to use the tool in a working environment with limited space as shown in FIG. 3. Also the stable rocker base 7 is shown retracted with spring button 5 protruding through pedestal 10 in position 13.

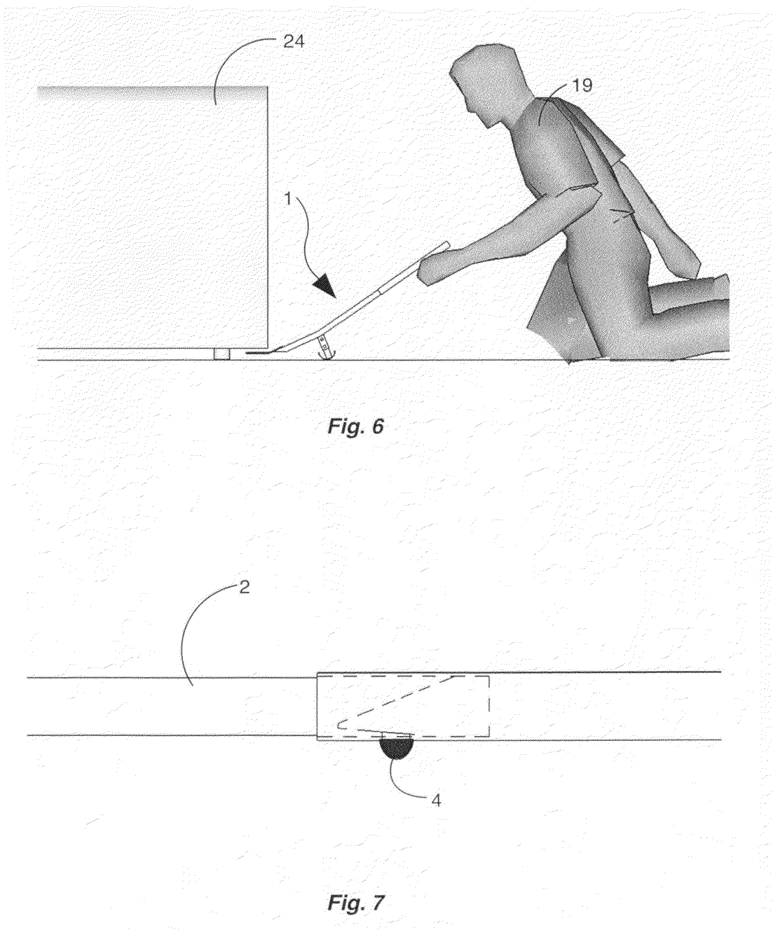

As depicted in FIG. 2C is a side view of lifting tool 1, with handle 3, shown in a extended position with hollow spring button 4 shown in position 17 of handle 3 to allow the operator 19 to use the tool to gain maximum mechanical advantage in a working environment. Also the stable rocker base 7 is shown extended with spring button 5 protruding through pedestal 10 in position 14 to allow user 19 maximum clearance for lifting an object that has an elevated base 24 as depicted in FIG. 6 For example, FIG. 3 shows lifting tool 1 being used with rocker base 7 retracted showing button 5 in position 13 of pedestal 6. The adjustable handle is shown with the spring pin 4 is protruding through handle position 15 to allow user 19 to use the lifting tool 1 in close quarters next to a wall 22.

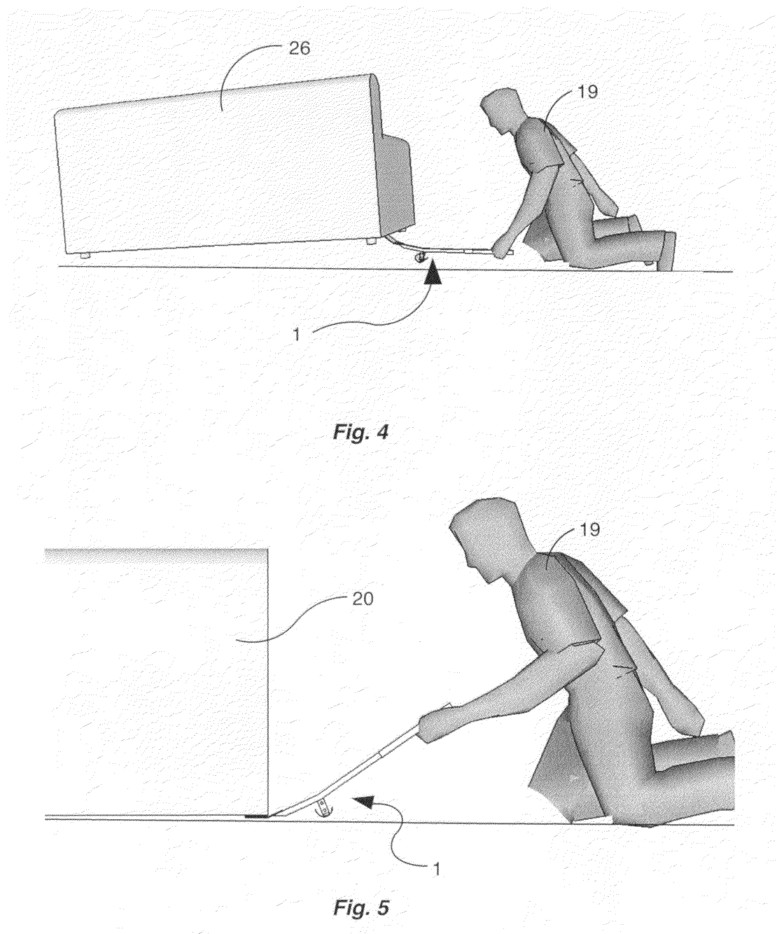

For example in FIG. 4 shows lifting tool 1 being used to lift heavy object 26 by user 19 with handle 3 in the extended position 17 for maximum leverage.

FIG. 5 depicts side view of tool 1 lifting an low object 23 with sturdy rocker base 7 retracted to base position with solid spring button 5 set to position 13 of pedestal 10.

FIG. 6 depicts side view of tool 1 lifting a high object 24 with sturdy rocker base 7 extended to raised height position with solid spring button 5 set to position 14 of pedestal 10 to allow maximum lifting height by user 19.

FIG. 7 depicts a detail of spring pin 4 and inside of main lifting arm 2.

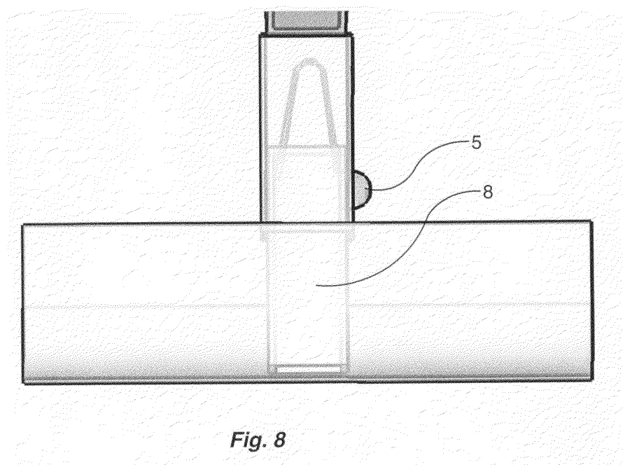

FIG. 8 depicts the detail of rocker base 8 and solid spring pin 5.

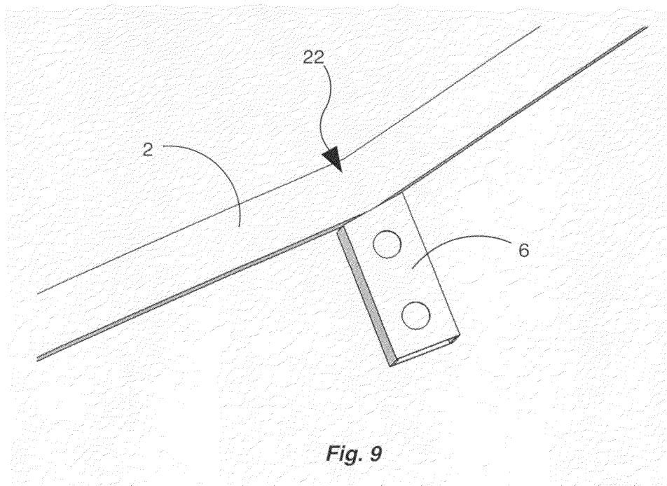

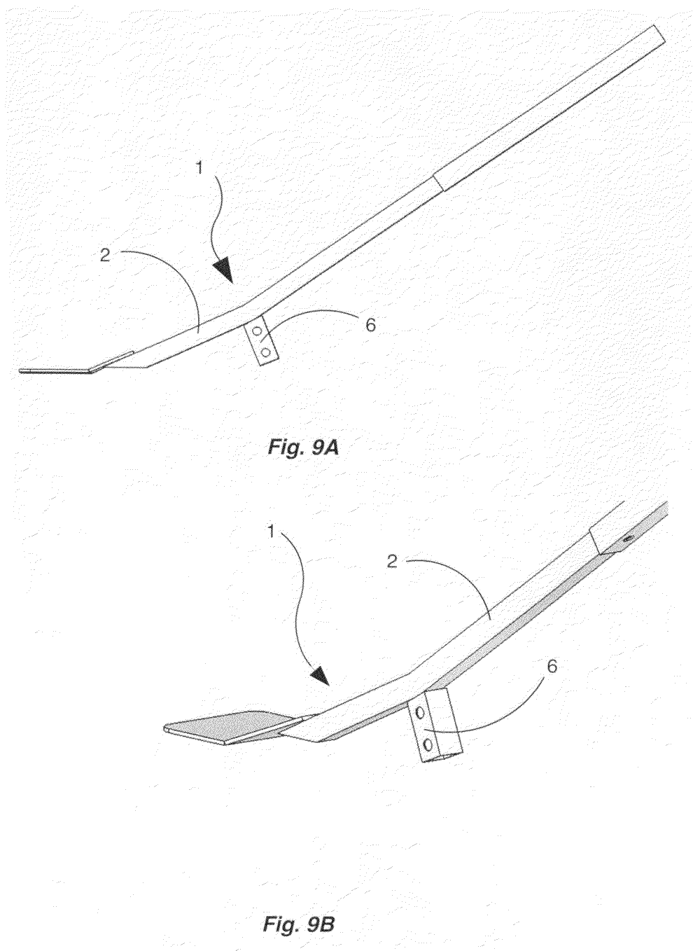

FIG. 9 depicts a detail of the placement of rocker base support leg 6. The placement of support leg 6 is a single pedestal attached to main lifting arm 2 placed immediately at vertex 22 as a means of support for main lifting arm 2. FIG. 9A is a side view of tool 1 showing orientation of support pedestal 6 placed at the vertex of main lifting arm 2 for maximum strength and stability. FIG. 9B is a section view of tool 1 showing the placement and orientation of a single pedestal 6 in relation to main lifting arm 2 showing view of single support pedestal for maximum strength and stability. In accordance with the teachings of the invention disclosed herein the applicant fabricated a working prototype to practice with favorable results. The prototype was fabricated from readily available materials. The main lifting arm 2 was constructed of ¾″ square steel tubing. The adjustable handle 3 is made of ⅞″ square steel tubing that has an internal dimension that allows a tight fit for adjustable handle 3 smooth telescopic function over main lifting arm 2. Surprisingly this allows a big advantage in allowing the handle to be retracted short enough to allow the tool 1 to function in close quarters with other objects. Other tools may have telescopic features where the handle portion slides inside the main body but does not allow for the full range of adjustability that this tool provides.

Similarly the pedestal 6 is constricted of ⅞″ tubing to allow rocker base 7 that uses ¾″ square tubing to fit inside pedestal 6 that also allows similar advantages as described above allowing the rocker base 7 maximum adjustability. The placement of pedestal 6 in relation to main lifting arm 2 is placed in such a way to distribute the force of the lifted item directly and squarely through the pedestal and rocker base to address bending problems experienced with similar lifting tools.

The rocker base is constructed of steel that has 1½″ radius that is 5½″ long to distribute the force of the lifted object over a greater area lessening the likelihood of damage to the floor surface, unlike similar lifting devices that do not distribute the load and may damage the surface. Rocker base 7 also is covered in a durable Teflon covering 8 to allow forward and backward movement of the tool as it rotates during a lift.

Another aspect of the lifting tool design is for the handle 3 to fit over main body 2 will also allow the tool to accept further attachments for future embodiments. The spring button used to secure the handle position makes switching of accessories safe and easy. Applicant successfully lifted and supported a variety of objects 20 including but not limited to a sofa, chair, entertainment center, desk, filling cabinet, industrial plainer, riding mower and other similar objects. Surprisingly the applicant discovered that the prototype was capable of handling loads of several hundred pounds at a wide variety of sizes and shapes with no difficulty. Surprisingly the instant invention provides an added advantage and recognizes a problem adequately and completely addressing an unfulfilled need in that the lifting tool in the manor disclosed, in effect, provides a convenient apparatus which allows the user to lift a variety of objects without the use of jack screws, scissors mechanisms and ratchet tools and provides the desired above mentioned advantages and benefits to the user.

It is understood that the lifting tool may be constructed in a wide variety of sizes and style variations. One practical advantage of the invention is that it provides a convenient, practical, low cost, lifting tool, which allows a user to conveniently lift various objects for a particular application, thereby saving time, money, and injury. A further advantage of the invention is that the instant invention is designed for ease of manufacturing by standard methods and by using readily available materials. Of course, a wide variety of further uses and advantages of the present invention will become apparent to one skilled in the art. Also, one skilled in the art will realize that the foregoing discussion outlines the more important features of the invention to enable a better understanding of the instant invention and to instill a better appreciation of the inventor's contribution to the art. It must be clear that the disclosed details of construction, descriptions of geometry, and illustrations of inventive concepts are examples of possible manifestations of the invention.

Although the invention has been shown and described with reference to certain preferred embodiments, those skilled in the art undoubtedly will find alternative embodiments obvious after reading this disclosure. With this in mind, these claims are intended to define the scope of protection to be afforded the inventor, and these claims shall be deemed to include equivalent constrictions insofar as they do not depart from the spirit and scope of the present invention.

What is claimed is:

1. An adjustable lifting tool comprising of:
a. A main lifting arm with a scoop at the distal end for engaging an object and a handle to be grasped by the user and a rocker base as a fulcrum.

2. An adjustable handle to be grasped by the user.
a. A main lifting arm that is slid inside the handle for a telescopic adjustment.
b. The adjustment of handle is facilitated with the use of a snap button to lock the handle in place at the desired position.
c. Telescopic handle feature is designed for use in a tight fitting area.

3. A single adjustable pedestal for a fulcrum on the main lifting arm.
a. A single rocker base of a certain length formed of a radius to distribute the weight evenly and a vertical support that fits inside the pedestal for telescopic height adjustment.
b. The radius of the rocker base is designed in such a way to allow the tool to move forward and backward when tool is rotated to lift an object.
c. The rocker base has a Teflon sheet surface to assist the sliding of the tool and to protect substrate finish.
d. The adjustment of the rocker base is facilitated with the use of a snap button of solid construction to bear the force of a lift and lock rocker base in desired position.
e. Telescopic rocker base feature is designed to allow for lifts of objects of various heights.

4. Referring to (1), the scoop's size and shape was chosen to allow off angle lifts or partial engagements lifts successfully

5. Referring to (1), a scoop that is attached to the lifting arm to engage an object for lifting.
